(19) United States
(12) Patent Application Publication
(10) Pub. No.: US 2016/0326026 A1
(43) Pub. Date: Nov. 10, 2016

(54) METHODS AND SYSTEMS FOR SEPARATING IONS FROM FLUIDS

(71) Applicant: INDIAN INSTITUTE OF TECHNOLOGY MADRAS, Chennai (IN)

(72) Inventors: Ramaprabhu Sundara, Chennai (IN); Ashish Kumar Mishra, Ghazipur (IN)

(21) Appl. No.: 15/214,192

(22) Filed: Jul. 19, 2016

Related U.S. Application Data
(62) Division of application No. 13/014,496, filed on Jan. 26, 2011.

(51) Int. Cl. C02F 1/469; C02F 1/461

(52) U.S. Cl. CPC C02F 1/4691; C02F 1/46114; C02F 2101/103

(57) ABSTRACT

Technologies are generally described for method and apparatus for separating ions, such as arsenic, from a fluid, such as water. The apparatus includes a capacitor. The capacitor includes a material having a nanoscale porous structure, such as a plurality of multi-walled carbon nanotubes (MWNTs), and metal oxide nanoparticles, such as magnetite, disposed over the nanoscale porous structure. A portable water purifier employing the capacitor can effectively remove ions from water with a low voltage applied to the capacitor.

### CROSS-REFERENCE TO RELATED APPLICATION

The present application is a divisional application under 35 U.S.C. §121 that claims priority under 35 U.S.C. §120 to U.S. patent application Ser. No. 13/014,496, entitled “METHODS AND SYSTEMS FOR SEPARATING IONS FROM FLUIDS,” filed on Jan. 26, 2011, and which is incorporated herein by reference in its entirety.

### TECHNICAL FIELD

The present disclosure is directed to methods and systems for removing ions from fluids, particularly water filters comprising carbon nanotubes.

### BACKGROUND

Unless otherwise indicated herein, the materials described in this section are not prior art to the claims in this application and are not admitted to be prior art by inclusion in this section.

The presence of toxic metals in ground water and sea water sources is an important issue in water and waste water treatment, as their consequences on human health have been well established. In particular, arsenic contamination of ground waters concerns many regions around the World.

Water has great abundance on the Earth. However, 97% of water is sea water. Sea water contains about 3.5% by weight of salt. For humans, excess intake of salt can result in high rates of cardiovascular disease, stroke, heart failure, and kidney disease. Along with a large amount of salt in sea water, a significant amount of arsenic is also present in sea water. The removal of arsenic is complicated by the fact that arsenite (AsO₃)³⁻ and arsenate (AsO₄)³⁻ are often both present in water, and no process is known to effectively remove both.

### SUMMARY

The inventors of the present application have recognized that, to use sea water as drinking water, there is a need to remove salt and both forms of arsenic (aresnite and arsenate) from sea water using an affordable water filtration system. It is also highly desirable to have such a system with low power consumption, such that communities with limited access to electricity can use such a system.

In one aspect, an apparatus is provided for separating ions from a fluid, such as water, electrolyte, or ionic liquids. The apparatus can include a capacitor. The capacitor can include a material having a nanoscale porous structure, such as a plurality of multi-walled carbon nanotubes (MWNTs), or a plurality of nanowires, or a plurality of graphenes, and metal oxide nanoparticles disposed over the nanoscale porous structure.

In one embodiment, the capacitor is a supercapacitor.

The capacitor can include a substrate having the plurality of MWNTs disposed thereon. The substrate can be flexible. In one example, the substrate comprises a graphitized carbon fabric. Other conductive substrates that do not react with the fluid can also be used.

In one example, the metal oxide nanoparticles include Fe₃O₄. In some other examples, the metal oxide nanoparticles include TiO₂ or CeO₂.

In one embodiment, the apparatus further includes a power supply for the capacitor. The power supply is configured to apply a voltage in the range of 0 V-1.2 V to the capacitor when used with water. For example, the voltage may be about 1 V. The power supply may include a DC power supply, an AC power supply, or both a DC and an AC power supply.

In one embodiment, the apparatus is configured to separate at least one of arsenate, arsenite, or sodium from water. The apparatus can be configured as a portable water purifier. The portable water purifier can have an adsorption capacity of at least 20 mg per gram of metal oxide—MWNTs composite for arsenate and at least 20 mg/g for arsenite. In one example, the adsorption capacity is about 39 mg/g for arsenate, and about 53 mg/g for arsenite under a voltage of about 1 V applied to the capacitor.

In one example, the portable water purifier can have an at least 50% removal efficiency for arsenic and sodium in about 15 cycles of operation. In other words, treating a solution containing an initial concentration of arsenic and/or sodium using the water purifier for 15 cycles of operation would reduce the concentration by at least 50% (the final concentration is less than 50% of the initial concentration). Higher examples of removal efficiency include at least about 60%, at least about 70%, at least about 80%, at least about 90%, at least about 95%, at least about 98%, at least about 99%, and ideally 100%. In another example, the portable water purifier has an at least 60% desalination efficiency for removing sodium, magnesium, and calcium from sea water in about 20 cycles of operation. Higher examples of removal efficiency include at least about 70%, at least about 80%, at least about 90%, at least about 95%, at least about 98%, at least about 99%, and ideally 100%. The portable water purifier can retain at least 90% of the water to be purified. In an ideal situation, the water purification can retain about 100% of the water to be purified. In other words, little or no water would be lost due to the purification process.

In one embodiment, the capacitor includes a first electrode and a second electrode. The apparatus further includes at least one channel for the fluid disposed between the first and second electrodes. First and second conductive supports are provided to support the first and second electrodes, respectively. First and second current collectors are disposed adjacent the respective first and second conductive supports. Each of the current collectors can comprise a stainless steel plate or an aluminum sheet, and each of the conductive supports comprises a graphite plate.

In another aspect, a method is provided for making an apparatus for separating ions from a fluid. The method includes disposing metal oxide nanoparticles over surfaces of a nanoscale porous structure. The materials having such a structure include, for example, a plurality of multi-walled carbon nanotubes (MWNTs), a plurality of nanowires, or a plurality of graphenes. The method further includes disposing the plurality of MWNTs over a substrate to form a first electrode of a capacitor.

In one embodiment, the method further includes forming the plurality of MWNTs through decomposition of acetylene on hydrogen decrepitated MmNi₃ alloy hydride particles using a single furnace chemical vapor deposition (CVD). Other methods such as laser ablation and arc discharging can also be used. The method can further include purifying the MWNTs using air oxidation technique followed by acid treatment, and functionalizing the purified MWNTs to be hydrophilic by refluxing the purified MWNTs with concentrated acid. The refluxing lasts about 12 hours, for example.

In one embodiment, the method further includes attaching hydrophilic oxygen-containing functional groups at surfaces of the MWNTs. In one example, the hydrophilic oxygen-containing functional groups include at least one of —COOH, —C═O, or —OH. Nitric acid can be used to obtain these functional groups. Other reagents can be used to functionalize with other functional groups. The method can further include washing the MWNTs with water until a solution containing the MWNTs has a substantially neutral acidity.

In one embodiment, the method further includes chemically reducing the MWNTs using metal salt precursor to disperse the metal oxide nanoparticles on the MWNTs. The functional groups can act as nucleation sites for the metal oxide nanoparticles. The functional groups can include at least one of a hydroxyl group, a carboxyl group, or a carbonyl group. The chemically reducing step can include dissolving FeCl₃.6H₂O and FeSO₄.7H₂O in deionized water in a stoichiometric ratio of 3:2 to form a first solution, heating the first solution to about 90° C., adding a second solution of NH₄OH (25%) and the MWNTs, in an volumetric ratio of 1:5, to the first solution, stirring the mixture of the first and second solutions at about 90° C. for about 30 min, cooling the mixture to room temperature, and filtering the mixture to collect the MWNTs having the metal oxide nanoparticles disposed thereon. Other chemical methods involving use of different reagents can also be employed.

In one embodiment, the metal oxide nanoparticles are attached to hydrophilic oxygen-containing functional groups, such as —COOH, —C═O and —OH, at surfaces of the MWNTs.

In one embodiment, the method further includes providing a gel solution of metal-oxide-MWNTs nanocomposite and a sulfonated tetrafluoroethylene based fluoropolymer-copolymer (such as NAFION), spray coating the gel solution over a the substrate to form the electrode of the capacitor, and hot pressing the electrode at about 50° C. under about 1 ton pressure for about 15 minutes to improve mechanical strength of the electrode, wherein the substrate comprises a carbon fabric. The parameters such as the force, temperature, and time will vary upon the amount and type of sample used, and the adhesion between the sample and the substrate. These parameters can be readily optimized using routine experimental procedures.

In one embodiment, the method further includes forming a second electrode of the capacitor, forming at least one channel for the fluid between the first and second electrodes, forming first and second conductive supports respectively for the first and second electrodes, and forming first and second current collectors respectively adjacent the first and second conductive supports, wherein the substrate is flexible.

In one embodiment, the substrate comprises a carbon fabric, each of the current collectors comprises a stainless steel plate, and each of the conductive supports comprises a graphite plate. Other conductive materials that aid in avoiding fluid leaks and do not react with the fluid can also be used as the conductive supports.

In another aspect, a method is provided for separating ions from a fluid. The method includes applying a voltage to a capacitor having the fluid disposed therein. The capacitor includes a material having a nanoscale porous structure, such as a plurality of multi-walled carbon nanotubes (MWNTs), a plurality of graphenes, or a plurality of nanowires, and metal oxide nanoparticles disposed over surfaces of the nanoscale porous structure. The fluid can comprise water, or other fluids that can function as electrolytes. Such electrolytes may be ionic liquid based fluids.

In one embodiment, the capacitor is a supercapacitor comprising a pair of electrodes, and wherein the fluid is disposed between the pair of electrodes. The voltage is in the range of greater than 0 V to 1.2 V. In one example, the voltage is about 1 V.

In one example, applying a voltage separates at least one of arsenate, arsenite, or sodium from the fluid.

In one embodiment, the MWNTs and the metal oxide nanoparticles have an adsorption capacity of at least 20 mg/g for arsenate and at least 20 mg/g for arsenite under the voltage applied to the capacitor. For example, the adsorption capacity can be about 39 mg/g for arsenate, and about 53 mg/g for arsenite under a voltage of about 1 V applied to the capacitor.

In one embodiment, the method further includes removing adsorbed ions from the MWNTs and the metal oxide nanoparticles by applying a reverse voltage to the capacitor. The reverse voltage can be about 0 V-1.2 V, for example.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A is a schematic diagram illustrating an apparatus for separating ions from a fluid in accordance with one embodiment, and a method of making the apparatus.

FIG. 1B is a schematic diagram illustrating the supercapacitor of the apparatus.

FIG. 2 is a TEM image of a nanocomposite comprising magnetite-coated MWNTs according to one embodiment.

FIG. 3 includes plots illustrating electrochemical activities of the nanocomposite and MWNTs for arsenic and salt removal.

FIG. 4 illustrates isotherm studies for simultaneous removal of both types of arsenic species and sodium.

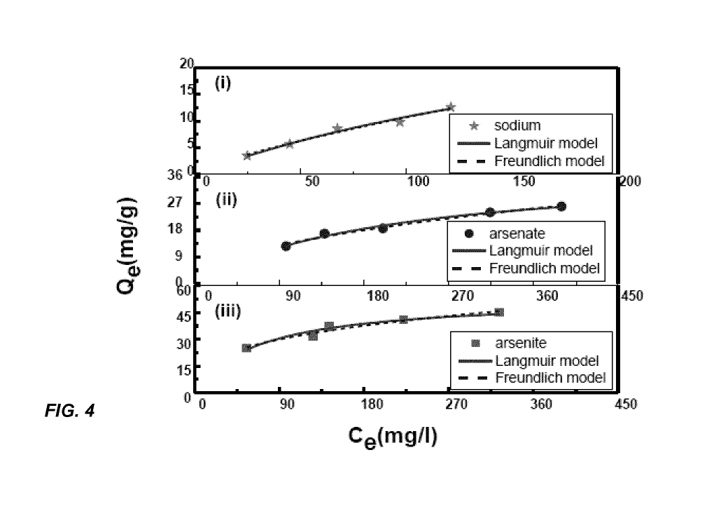

FIG. 5 illustrates the nanocomposite's simultaneous removal efficiency for sodium and arsenic.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Methods, apparatus, systems, and devices related to separating ions, such as arsenic, from a fluid, such as water are disclosed. The apparatus includes a capacitor. The capacitor includes a plurality of multi-walled carbon nanotubes (MWNTs), and metal oxide nanoparticles, such as magnetite, disposed over the plurality of MWNTs. A portable water purifier employing the capacitor can effectively remove impurity ions from water with a low voltage applied to the capacitor.

In an example, nanocrystalline magnetite nanoparticles are decorated or dispersed on the surface of multiwalled carbon nanotubes (MWNTs) using a chemical reduction method, thereby forming a nanocomposite. In one embodiment, the nanocomposite is used as a supercapacitor electrode material for water purification. The nanocomposite is coated on graphitized carbon fabric to form an electrode for the super capacitor.

The magnetite decorated MWNTs electrodes in the supercapacitor show high level of electrochemical activity towards salt and arsenic removal compared with pure MWNTs. The apparatus disclosed herein is capable of removing both types of inorganic arsenic species (arsenate and arsenite) from water. In one embodiment, the apparatus can desalinate sea water up to about 70% in 20 cycles. The system also has been demonstrated at a 1 V power supply.

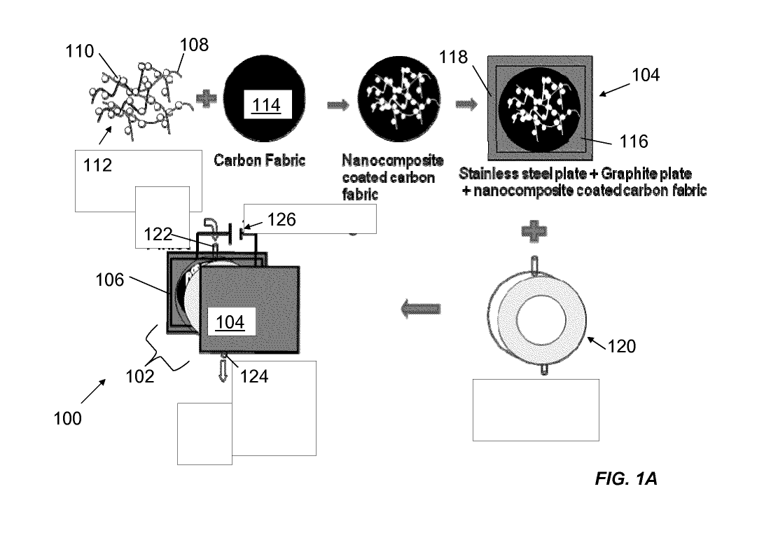

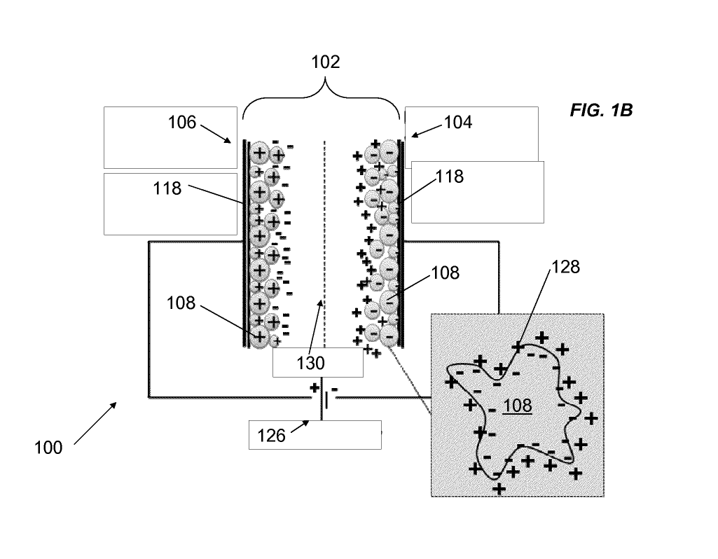

FIG. 1A is a schematic diagram illustrating an apparatus 100 for separating ions from a fluid, and the method of making the apparatus. The apparatus 100 comprises a capacitor 102 including a first electrode 104 and a second electrode 106. The capacitor 102 includes a nanoscale porous structure, such as a plurality of MWNTs 108, or graphenes or nanowires, and metal oxide nanoparticles 110 disposed over the nanoscale porous structure. The metal oxide nanoparticles 110 and the plurality of MWNTs 108 form a nanocomposite 112.

The nanocomposite 112 is disposed over a substrate (e.g., carbon fabric) 114, which in turn is disposed over a conductive support 116 (e.g., a graphite plate) on a current collector 118. The current collector 118 can be made of, for example, a stainless steel plate or an aluminum sheet.

A channel or container 120 for the fluid is disposed between the first and second electrodes 104, 106, and allows the fluid (e.g., water) to flow between and make contact with the first and second electrodes 104, 106. The electrodes 104, 106 can act as side walls of the channel 120, and provide contact between the fluid and the electrode surfaces. The fluid can continuously flow through the channel 120 through the inlet 122 and the outlet 124. A power supply 126 applies a voltage to the capacitor 102.

As illustrated in FIG. 1B, the capacitor 102 can be considered a supercapacitor because the MWNTs 108 allow the nanoscale spaces between the tubes (pores) have the fluid (e.g., water) contained therein, and the fluid acts as an electrolyte. The nanoporous property of the MWNTs result in a drastically increased surface area, and thus increased capacity.

When a voltage is applied across the electrodes 104, 106, the ions move towards the oppositely charged electrodes. For example, positively charged ions 128 move toward the negatively charged electrode 104. They are believed to reach the surface of electrodes and take the position in the available pores of electrode material, such as on the surface of the MWNT 108 as shown. Hence the electrolytic ions and the electrode surface are separated with a very small distance (of the order of angstrom range), and form the layer of ions at each electrode surface. This is believed to result in formation of two layers (charged electrode and ions) at electrode-electrolyte interface, and the supercapacitor 102 can also be referred to as an electrochemical double-layer capacitor. A separator 130 can be included in the supercapacitor 102 to provide insulation between the electrodes 104, 106, and to allow ionic conduction between the electrodes 104, 106.

Other types of porous materials having a nanoscale structure can be used to have the metal oxide nanoparticles disposed thereon. Such materials can include, for example, graphenes, which can provide large contact areas.

The power supply 126 can apply a voltage, e.g., greater than 0 V to about 1.2 V, to the capacitor 102, if the fluid is water and the apparatus 100 is configured as a water filtration system. In one embodiment, the voltage is about 1 V. For other types of non-aqueous electrolytes, the voltage can be higher, such as higher than 1.2 V.

The apparatus 100 can be configured to separate at least one of arsenate, arsenite, or sodium from water, and can be configured as a portable water purifier as a result of the low voltage used. The portable water purifier can have an adsorption capacity of at least 20 mg/g for arsenate and at least 20 mg/g for arsenite, for example. Under a voltage of about 1 V applied to the capacitor 102, the adsorption capacity can be about 39 mg/g for arsenate, and about 53 mg/g for arsenite.

In one example, the portable water purifier has an at least 50% removal efficiency for arsenic and sodium in about 15 cycles of operation. In other words, treating a solution containing an initial concentration of arsenic and/or sodium using the water purifier for 15 cycles of operation would reduce the concentration by at least 50% (the final concentration is less than 50% of the initial concentration). Higher examples of removal efficiency include at least about 60%, at least about 70%, at least about 80%, at least about 90%, at least about 95%, at least about 98%, at least about 99%, and ideally 100%.

In one example, the portable water purifier can have an at least 60% desalination efficiency for removing sodium, magnesium, and calcium from sea water in about 20 cycles of operation. Higher examples of desalination efficiency include at least about 70%, at least about 80%, at least about 90%, at least about 95%, at least about 98%, at least about 99%, and ideally 100%. In one embodiment, the portable water purifier can retain at least 90% of the water to be purified. Higher examples water retention include at least about 90%, at least about 95%, at least about 98%, at least about 99%, and ideally 100%.

### EXAMPLES

### Example 1

### Preparation of MWNTs

MWNTs can be synthesized by the decomposition of acetylene on hydrogen decrepitated MmNi₃ alloy hydride particles using a single furnace chemical vapor deposition (CVD) technique. The MWNTs can then be purified using air oxidation technique followed by acid treatment. Purified MWNTs are further functionalized to achieve the hydrophilic property by refluxing with concentrated acid for about 12 h. This leads to the attachment of hydrophilic oxygen-containing functional groups (—COOH, —C═O and —OH) at MWNTs surface.

The MWNTs are then washed several times with a copious amount of water till the solution containing the MWNTs has a substantially neutral acidity, e.g., the pH value is about 7. Functional groups present on the MWNTs surface not only impart them hydrophilic nature but also act as anchoring sites for metal and metal oxide nanoparticles. Metal oxide (e.g., magnetite) coated MWNTs nanocomposite is prepared by chemical reduction method using metal salt precursor and functionalized MWNTs, where metal oxide gets dispersed on MWNTs. The attached hydroxyl, carboxyl and carbonyl groups to the surface of functionalized MWNTs provide nucleation sites for the metal oxide nanoparticles.

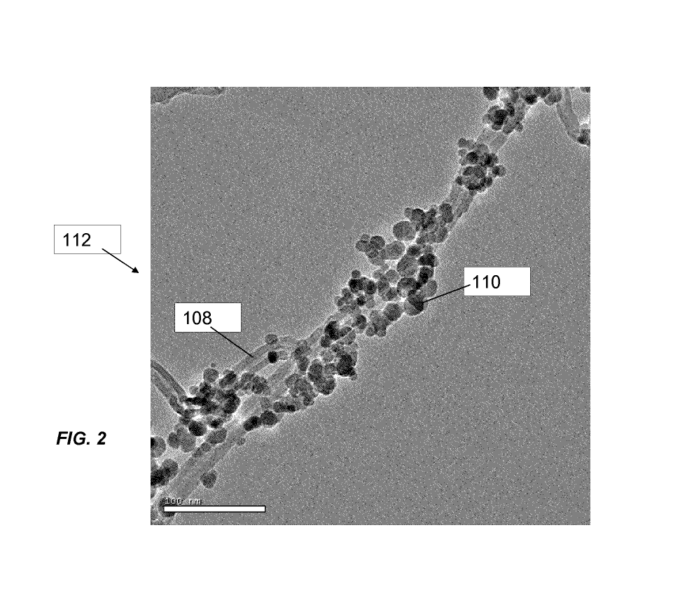

Salts FeCl₃.6H₂O and FeSO₄.7H₂O are dissolved in deionized water in the stoichiometric ratio of 3:2. This solution has been heated up to 90° C. NH₄OH (25%) and MWNTs dispersed solution, in the volumetric ratio of 1:5, have been added in the above solution. This mixture solution is stirred at about 90° C. for about 30 min and then cooled to room temperature. The black precipitate is collected by filtrating and washed to neutral with water. The obtained black precipitate is Fe₃O₄-MWNTs nanocomposite. TEM image of this nanocomposite 112 is shown in FIG. 2A, which illustrates the uniform decoration of magnetite nanoparticles 110 over the surfaces of MWNTs 108. Fe₃O₄ nanoparticles have better affinity towards arsenic species. Thus, the decoration of Fe₃O₄ nanoparticles allows the additional chemisorptions of arsenic species at electrodes along with double layer formation at each electrode. Pure metal oxide nanoparticles can have the tendency to agglomerate, reducing the surface areas. The use of MWNTs can avoid the agglomeration of nanoparticles and provide distribution sites for nanoparticles and hence more use of nanoparticles for ion adsorption. Other types of metal oxide nanoparticles, such as TiO₂ or CeO₂, may also be used.

### Example 2

### Preparation of Apparatus

Electrodes can be prepared using a gel solution of magnetite-MWNTs nanocomposite and NAFION. Carbon fabric can be used as a substrate for electrode preparation. Gel solution was coated on carbon fabric using a spray coating technique. These electrodes are hot pressed at 50° C. under a 1 ton force for about 15 minutes to provide good mechanical strength to the electrodes. Other coating techniques such as screen printing, or doctor blades, can be used.

In one example, a cylindrical Perspex having a length of 2 cm, a width of 0.5 cm, and a diameter of 4 cm is used for water collection between the electrodes. At both ends, Fe₃O₄-MWNTs nanocomposites disposed over flexible carbon fabrics are fixed as electrode. Stainless steel plates are used as current collector. Graphite plates to provide conductive support to the electrodes. A DC regulated power supply can be used to apply a voltage of about 1 V across the electrodes.

### Example 3

### Analysis of Electrochemical Activities of the Apparatus

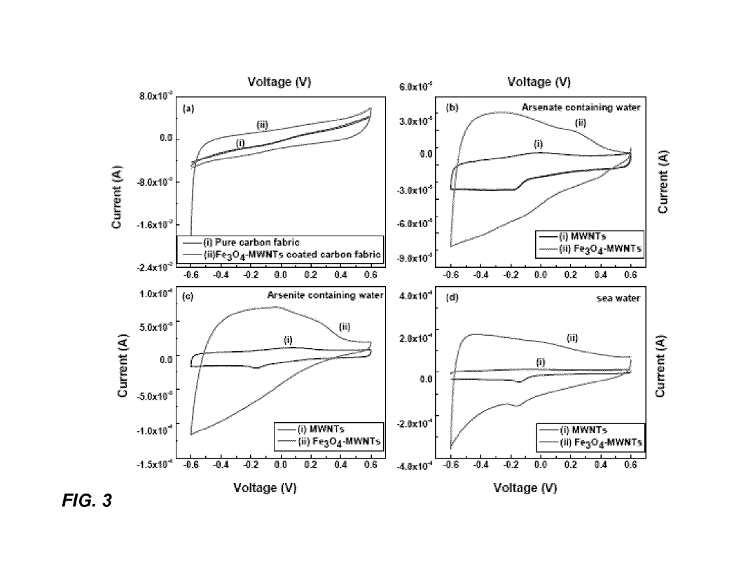

In order to confirm the chemical inertness of carbon fabric towards metallic ions, CV was performed with Fe₃O₄-MWNTs nanocomposite coated carbon fabric in comparison with pure carbon fabric as supercapacitor electrodes with 1 M sodium hydroxide (NaOH) as an electrolyte. FIG. 3 includes plots illustrating electrochemical activities of the nanocomposite and MWNTs for arsenic and salt removal. The scan rate in the CV measurements is about 10 mV/s. In panel (a) of FIG. 3, nanocomposite-coated carbon fabric shows a large capacitance while pure carbon fabric shows neither a formation of double layer nor any oxidation-reduction peaks. This suggests that carbon fabric has no electrochemical activity, therefore it can be used as a substrate for nanocomposite-based supercapacitor electrodes.

In addition, CV was performed to check the electrochemical activity of MWNTs and Fe₃O₄-MWNTs nanocomposite towards arsenate, arsenite and sodium ions. In the CV analysis, Ag/AgCl and Pt wire electrodes were taken as reference and counter electrodes, respectively, while MWNTs-modified glassy carbon (GC) electrode and Fe₃O₄-MWNTs-nanocomposite-modified GC electrode were taken as working electrodes. CV analysis was performed on water containing arsenate and arsenite ions as well as sea water as electrolytes using a constant scan rate of 5 mV/s for each analysis.

Panel (b) of FIG. 3 shows the cyclic voltammograms of sodium arsenate solution as an electrolyte. A cathodic peak was observed for MWNTs at −0.16V. A very small anodic peak for nanocomposite at 0.22V was observed. In the case of sodium arsenite solution as electrolyte, panel (c) shows the cathodic peak for MWNTs at −0.16V as well as a very small anodic peak for nanocomposite at 0.24V. In the case of sea water, panel (d) shows the cathodic peaks for MWNTs and nanocomposite at −0.15V.

Anodic peaks (arsenite and arsenate ions based water) may represent oxidation of arsenite to arsenate or of elemental arsenic to arsenite while the cathodic peaks (arsenate, arsenite based water and sea water) correspondingly, may stand for reduction from arsenate to arsenite or from arsenite to elemental arsenic. The almost-rectangular shapes of cyclic voltamograms obtained with each electrolyte suggest the formation of double layer at the electrode and electrolyte interface for both materials. High capacitive behavior, high cathodic and anodic current suggest that Fe₃O₄-MWNTs nanocomposite has more activity towards water containing arsenate and arsenite ions and sea water than MWNTs.

Under the influence of the electrostatic force, positive and negative charge species are attracted towards the opposite charged electrodes of the supercapacitor. When these ions reach to the surface of electrodes, due to the large number of anchoring sites at the surface of Fe₃O₄-MWNTs nanocomposite, they get adsorbed at the surfaces of the nanocomposites.

Functional groups may create the intermediate bonding between water molecules and MWNTs, which provides better contact between the electrodes and electrolyte (water), and leads to high capacitance of the supercapacitor due to small distances between the electrode interfaces and electrolytic ions. This suggests a larger number of ions at the electrode interfaces and hence more salt and arsenic removal at a single treatment. After continuous cycles of treatment, due to adsorption of sodium and arsenic ions, the number of available anchoring sites reduces. To regain the anchoring sites of the electrode material, a reverse voltage can be applied with an optimized fast flow of water. The reverse voltage can be also in the range of about 0 V-1.2 V, such as about 1 V. Under the influence of the reverse voltage, the adsorbed ions at the electrodes get detached and come out along with water, and the electrodes regain their anchoring sites for further use.

The quantity of the metallic impurities that can be adsorbed at nanocomposite surface is a function of concentration, which can be explained by the adsorption isotherms. For example, Langmuir and Freundlich isotherms can be tested with the removal of sodium and arsenic (both arsenate and arsenite types). Water containing sodium arsenate and sodium arsenite having different initial arsenic concentrations varying from 200 to 400 ppm was used for the study. FIG. 3 shows the comparative fit of Langmuir and Freundlich isotherms with the equilibrium data plotted as an amount of metal impurity adsorbed per unit weight of adsorbent (Qₑ) vs. equilibrium concentration of water (Cₑ) for both types of arsenic ions and sodium. Maximum adsorption capacities of 53 mg/g for arsenite, 39 mg/g for arsenate, and 37.8 mg/g for sodium were obtained.

ICP-OES analysis was performed to verify the assumption of CV, which suggests that Fe₃O₄-MWNTs nanocomposite is a good electrode material for the supercapacitor used as a water filter. ICP-OES analysis gives the actual concentration of metal ions in the solution. A percent removal efficiency was calculated using the following formula: % removal efficiency=(C₀−C_{f})100/Co, where C₀ is the initial concentration of metal impurity in the water, and C_{f} is the final concentration of metal impurity in the water after treatment.

### Example 4

### Use of the Apparatus as a Water Purifier

The apparatus can be configured as a water purifier, such as a portable water purifier for removing undesired ions from water and/or desalinating sea water.

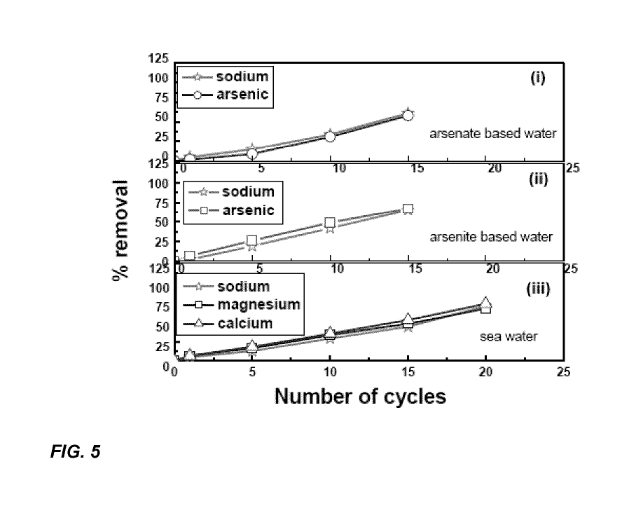

FIG. 5 shows the removal efficiency for sodium, both types of arsenic ions, and for desalination of sea water. Nearly 58% of arsenic (As) and 61% of sodium (Na) removal efficiency was obtained in the case of water containing sodium arsenate, while in the case of water containing sodium arsenite, it was found to be 67% and 65% for As and Na, respectively, with 15 number of repeated cycles and 100 mg of nanocomposite loading at each electrode. In each case the initial concentration of arsenic was around 400 ppm. Nearly equal % removal of As and Na in either case suggests the removal of each metallic impurity without getting affected by the other impurities. The almost linear variation in the plots suggests the good cyclic repeatability of electrodes for simultaneous removal of arsenic and sodium.

Good cyclic repeatability for metal removal performance suggests that the apparatus disclosed herein can be used for the purification of water (sea water) containing high concentrations of multiple metal impurities. Desalination (removal of sodium, magnesium and calcium) of sea water was checked with 100 mg loading of MWNTs at each electrode. Desalination efficiency was found to be 70% for sodium, 67% for magnesium and 73% for calcium with 20 numbers of repeated cycles. Initial concentrations were found to be 9870, 1750 and 540 ppm for sodium, magnesium, and calcium, respectively. Linear variation of removal efficiency with respect to different numbers of cycles was observed. Nearly equal amount of removal for each metal was seen in sea water with different numbers of cycle. This suggests the good efficiency of the apparatus for the removal of multiple metal impurities from water, and the cyclic repeatability and hence reproducibility of electrodes for desalination of sea water.

Data also show that the voltage applied to the capacitor significantly affects the effectiveness in removing the ions from the fluid. For example, without any applied voltage, only adsorptions at pores are involved, resulting in an adsorption capacity of 5.0 mg/g for arsenate (As V) and 12.92 mg/g for arsenite (As III). The efficiency of the example apparatus at an applied voltage of 1 V has an adsorption of 39 mg/g for arsenate and 53 mg/g for arsenate. The voltage makes a significant difference in the amount of impurities removed because most of the metal impurities are ionic in nature in their salt solutions. In addition, the nano-structured pores of the nanocomposite provide additional area for greater effectiveness.

Sufficient adsorption sites (porous surface area) will be available to form double layers. Thus, the apparatus is effective in the removal of arsenic at low concentrations. The electric field from the applied voltage brings metal impurities adjacent to the electrodes surface. The electrolysis process results in the ions moving towards opposite electrodes. At the low concentrations, movement of metal impurities (ions) will be easier under the electric field, and hence more metal removal will be possible. If the concentration of electrolyte is high, the movement of ions may be hindered due to collisions among the ions.

In the case of simple adsorption of multiple metal impurities (ions), competition between different ions takes place, and different metal impurities will not have equal adsorptions. It has been shown that the affinities of the three metal ions adsorbed by CNTs are in the order of Pb²⁺>Cu²⁺>Cd²⁺.

In contrast, under the applied voltage, the example apparatus disclosed herein shows almost equal percentage removal of different metal impurities.

The apparatus and methods disclosed herein therefore provide a platform for the development of low-cost portable water filters for desalination of sea water. Nanocomposite-based water filters in accordance with embodiments disclosed herein can also be used for ground water purification where arsenic level is high.

Existing technologies for converting sea water into fresh water, such as multi-stage flash, multiple effect distillation, vapor compression distillation, reverse osmosis, and electric dialysis have systems that are maintenance extensive, require complex pre-treatment (heating, condensing, and chemically pretreating arsenite to convert to arsenic) of sea water, and have high energy consumption. The apparatus disclosed herein has better electrochemical activities towards the metallic impurities in water. The apparatus can function using a 1V power supply, resulting in reduced energy consumption, thereby allowing the apparatus to be powered by renewable energy sources and batteries.

Existing methods of water purification such as distillation and reverse osmosis also consume a large volume of water. In some cases, the final product (pure water) is only about 10-30% of the input water. In some embodiments, the apparatus disclosed herein on the other hand may consume considerably less water. For example, the final product (pure water) can be about 90% of the input water, e.g., in the range of 85-95%.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-20. (canceled)

21. A method to make an apparatus configured to separate ions from a fluid, the method comprising:
forming a first electrode, wherein forming the first electrode comprises:
disposing first metal oxide nanoparticles onto a surface of a first material formed from a first plurality of multi-walled carbon nanotubes to form a first nanocomposite;
disposing the first nanocomposite over a first substrate; and
disposing the first substrate over a first conductive support on a first current collector;
forming a second electrode, wherein forming the second electrode comprises:
disposing second metal oxide nanoparticles onto a surface of a second material formed from a second plurality of multi-walled carbon nanotubes to form a second nanocomposite;
disposing the second nanocomposite over a second substrate; and
disposing the second substrate over a second conductive support on a second current collector; and
forming a channel between the first electrode and the second electrode, wherein the channel is configured to receive the fluid.

22. The method of claim 21, wherein disposing the first metal oxide nanoparticles comprises using a chemical reduction process to dispose the first metal oxide nanoparticles.

23. The method of claim 21, further comprising coupling a power supply to the first electrode and the second electrode, wherein the power supply is configured to provide a voltage across the first electrode and the second electrode such that the ions are separated from the fluid.

24. The method of claim 21, further comprising forming the first plurality of multi-walled carbon nanotubes through decomposition of acetylene on hydrogen decrepitated MnNi₃ alloy hydride particles.

25. The method of claim 24, wherein forming the first plurality of multi-walled carbon nanotubes comprises using single furnace chemical vapor deposition.

26. The method of claim 21, further comprising attaching hydrophilic oxygen containing functional groups to surfaces of the first plurality of multi-walled carbon nanotubes.

27. The method of claim 21, further comprising washing the first plurality of multi-walled carbon nanotubes with water until a solution that contains the first plurality of multi-walled carbon nanotubes has a neutral acidity.

28. The method of claim 21, wherein disposing the first metal oxide nanoparticles onto the surface of the first material formed from the first plurality of multi-walled carbon nanotubes comprises reducing the first plurality of multi-walled carbon nanotubes using a metal salt precursor to disperse the metal oxide nanoparticles onto the first plurality of multi-walled carbon nanotubes.

29. The method of claim 28, wherein reducing the first plurality of multi-walled carbon nanotubes using the metal salt precursor comprises:
dissolving FeCl₃6H₂O and FeSO₄7H₂O in deionized water to form a first solution;
heating the first solution to 90 degrees Celsius;
forming a second solution that includes the first multi-walled carbon nanotubes and adding the second solution to the first solution;
stirring a mixture of the first solution and the second solution for approximately 30 minutes;
cooling the mixture to room temperature; and
filtering the mixture to collect the first multi-walled carbon nanotubes with the metal oxide nanoparticles dispersed thereon.

30. The method of claim 29, wherein the FeCl₃6H₂O and the FeSO₄7H₂O are dissolved in the deionized water in a stoichiometric ratio of 3 to 2.

31. The method of claim 29, wherein forming the second solution comprises adding NH₄OH to the first multi-walled carbon nanotubes in a volumetric ratio of 1 to 5.

32. A method to make an apparatus configured to separate ions from a fluid, the method comprising:
forming a first plurality of multi-walled carbon nanotubes and a second plurality of multi-walled carbon nanotubes;
forming a first electrode by disposing first metal oxide nanoparticles onto a surface of the first plurality of multi-walled carbon nanotubes;
forming a second electrode by disposing second metal oxide nanoparticles onto a surface of the second plurality of multi-walled carbon nanotubes; and
forming a channel between the first electrode and the second electrode, wherein the channel is configured to receive the fluid.

33. The method of claim 32, wherein disposing the first metal oxide nanoparticles comprises using a chemical reduction process to dispose the first metal oxide nanoparticles onto the first plurality of multi-walled carbon nanotubes.

34. The method of claim 32, wherein forming the first plurality of multi-walled carbon nanotubes comprises decomposing acetylene on hydrogen decrepitated MnNi₃ alloy hydride particles.

35. The method of claim 32, wherein forming the channel includes forming the channel such that the first electrode and the second electrode are side walls of the channel.

36. The method of claim 35, further comprising forming an inlet and an outlet for the channel such that the fluid can flow continuously through the channel.

37. The method of claim 32, further comprising attaching hydrophilic oxygen containing functional groups to surfaces of the first plurality of multi-walled carbon nanotubes.

38. A method to make an apparatus configured to separate ions from a fluid, the method comprising:
forming a first electrode by disposing first metal oxide nanoparticles onto a surface of a first nanoscale porous structure;
forming a second electrode by disposing second metal oxide nanoparticles onto a surface of a second nanoscale porous structure;
forming a channel between the first electrode and the second electrode such that the first electrode and the second electrode are side walls of the channel, wherein the channel is configured to receive the fluid;
forming an inlet and an outlet for the channel such that the fluid can flow continuously through the channel; and
coupling a power supply to the first electrode and the second electrode, wherein the power supply is configured to provide a voltage across the first electrode and the second electrode such that the ions are separated from the fluid.

39. The method of claim 38, further comprising attaching hydrophilic oxygen containing functional groups to surfaces of the first nanoscale porous structure.

40. The method of claim 38, wherein the first nanoscale porous structure comprises multi-walled carbon nanotubes, the method further comprising forming the multi-walled carbon nanotubes through decomposition of acetylene on hydrogen decrepitated MnNi₃ alloy hydride particles.
